(19) United States
(12) Patent Application Publication
(10) Pub. No.: US 2009/0102945 A1
(43) Pub. Date: Apr. 23, 2009

(54) SYSTEM AND METHOD FOR GENERATING HIGH DYNAMIC RANGE IMAGES

(75) Inventor: Ching-Hung Chen, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/118,938

(22) Filed: May 12, 2008

(30) Foreign Application Priority Data
Oct. 23, 2007 (CN) 200710202226.X

(51) Int. Cl. H04N 5/235

(52) U.S. Cl. 348/229.1; 348/E05.034

(57) ABSTRACT

Generating a high dynamic range image includes obtaining a maximum luminance and a minimum luminance of a scene to be captured, setting a first range of exposure values and a second range of exposure values according to the maximum luminance and the minimum luminance, capturing a first image of the scene according to the first range of exposure values and a second image of the scene according to the second range of exposure values, and superposing the images by compositing luminance information of pixels in corresponding locations of the images according to a tone mapping technique.

### BACKGROUND

1. Technical Field

The present invention generally relates to a system and method for processing images, and especially to a system and method for generating high dynamic range images by processing images.

2. Description of Related Art

High dynamic range imaging (HDRI) is a technique developed for photographing scenes that include disparate ranges of brightness. For example, if a photographer attempts to capture an image of an outdoor scene through a window of a room, regions of the image corresponding to the room may have a brightness range that is much lower than a brightness range for regions of the image corresponding to the window. Typically, if an auto-brightness function of a digital camera is employed, this will result in either the room being too dark in the image, or in the window being washed out. These two conditions occur due to limitations on a total brightness range available, which is typically represented by brightness levels ranging from 0-255.

HDRI, therefore, was originally developed for use with purely computer-generated images. Later, methods were developed to produce a high dynamic range (HDR) image from a set of images acquired under different ranges of exposure. With the rising popularity of digital cameras and easy-to-use desktop software, the term “HDR” is now popularly used to refer to a process of tone mapping (a technique of converting HDR images into a viewable image), which gives an end result that often exhibits a high, exaggerated dynamic range. This composite technique is different from, and generally of lower quality than, the production of an image from a single exposure coming from a sensor having a high dynamic range natively.

However, for common digital cameras, the following steps are needed for acquiring an HDR image: capturing a number of images over a range of exposure settings determined by a user; outputting the images captured to a computer; filtering overexposed and underexposed images via the computer; and acquiring the HDR image by combining the remaining images via a tone mapping technique in the computer. Thus, it can be seen that HDR images are difficult to generate with the common digital cameras.

### SUMMARY

A system for generating HDR images is provided. A system for acquiring high dynamic range (HDR) images, the system running in an electronic device, the system comprising: a luminance acquisition module configured for obtaining a maximum luminance and a minimum luminance of a scene to be captured; an exposure value setting module configured for setting a first range of exposure values of the electronic device and a second range of exposure values of the electronic device according to the maximum luminance and the minimum luminance; and an image compositing module configured for receiving a first image of the scene captured according to the first range of exposure values and a second image of the scene captured according to the second range of the exposure values, and generating the HDR image by compositing luminance information of first pixels of the first image and luminance information of second pixels of the second image, the first pixels having corresponding locations in the first image to locations of the second pixels in the second image.

A method for generating a high dynamic range (HDR) image, the method comprising: obtaining a maximum luminance and a minimum luminance of a scene to be captured; setting a first range of exposure values and a second range of exposure values both corresponding to the maximum luminance and the minimum luminance; capturing a first image of the scene according to the first range of exposure values comprising a first pixel located at a first location having color information and luminance information, and a second image of the scene according to the second range of exposure values comprising a second pixel located at a second location corresponding to the first location having color information and luminance information; and superposing the first image and the second image by compositing the luminance information of the first pixel and the luminance information of the second pixel according to a tone mapping technique to generate the HDR image.

Other objects, advantages and novel features of the embodiments will be drawn from the following detailed description together with the attached drawings.

### BRIEF DESCRIPTION OF THE DRAWINGS

FIG. 1 is a schematic diagram of an application environment of an electronic device for generating HDR images in accordance with an exemplary embodiment.

FIG. 2 is schematic diagram of function modules of the HDR images generating system of FIG. 1.

FIG. 3 is a flow chart of a method for generating HDR images in accordance with the exemplary embodiment.

### DETAILED DESCRIPTION OF THE EMBODIMENTS

In order to describe the exemplary embodiments conveniently, here we explain the following technical terms:

Tone mapping: One problem with HDR is in viewing the HDR images. CRTs, LCDs, prints, and other methods of displaying images have a limited dynamic range. Thus, various methods for converting HDR images into a viewable format, generally called “tone mapping,”

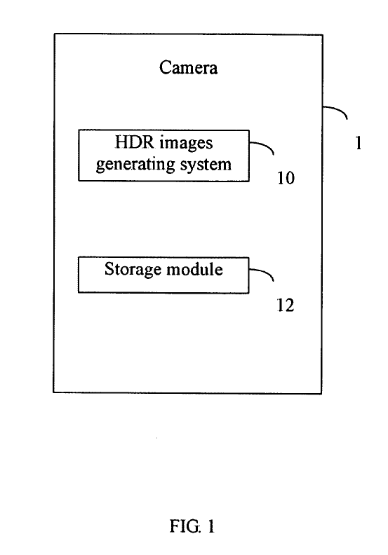

FIG. 1 is a schematic diagram of an application environment of an electronic device generating HDR images in accordance with an exemplary embodiment. A HDR images generating system (hereinafter, “the system”) 10 may run in the electronic device such as a camera, a mobile phone with a charge coupled device (CCD) or any other digital apparatus with a CCD. In the exemplary embodiment, the system 10 runs in a camera 1. The camera 1 further includes a storage module 12. The storage module 12 may be, but is not limited to, a flash memory, which can be built-in or external to the camera 1. The system 10 may provide various modes to acquire images, such as a normal mode, an HDR mode, and so on. If a user selects the HDR mode to acquire the images, the system 10 starts to run. The system 10 is configured for obtaining a maximum luminance and a minimum luminance of a scene to be captured. The system 10 may set a plurality of ranges of exposure values, e.g. a first range of exposure values and a second range of exposure values, of the camera 1 according to the maximum luminance and the minimum luminance. The system 10 may then acquire a number of images from the camera 1. A first image of the scene may be captured according to the first range of exposure values, and a second image of the scene may be captured according to the second range of exposure values. Of course, number of ranges of exposure values and number of images captured according to each range of exposure values is not limited. Each image may comprise pixels, with each pixel having three bytes of red-green-blue (RGB) color information and corresponding luminance information. The system 10 may superpose the images, such as the first image and the second image, to generate an HDR image by compositing the luminance information pixels in corresponding locations in each image according to a tone mapping technique. Preferably, the maximum and minimum luminance values of the scene to be captured are between 0 and 255. The storage module 12 stores the HDR image in a designated format, e.g. a JPEG format or a raw format.

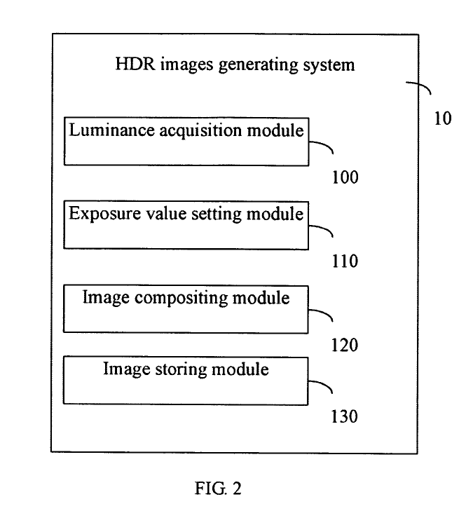

FIG. 2 is a schematic diagram of functional modules of the HDR image acquiring system of FIG. 1. The system 10 includes a luminance acquisition module 100, an exposure value setting module 110, an image compositing module 120 and an image storing module 130. After the user selects the HDR mode for generating the HDR image, the camera 1 runs the system 10. The luminance acquisition module 100 is configured for obtaining the maximum luminance and the minimum luminance of the scene to be captured. Generally, the maximum luminance and the minimum luminance of the scene to be captured are between 0 to 255. For example, the maximum luminance of the scene may be 180, and the minimum luminance of the scene may be 90. The exposure value setting module 110 is configured for setting a plurality of ranges of exposure values within the maximum luminance and the minimum luminance. For example, the ranges of the exposure values may be set as 90 to 120, 120 to 150, and 150 to 180. After the ranges of the exposure values are set, the user may press a shutter button of the camera 1, so that the camera 1 automatically captures a number of images of the scene corresponding to the number of ranges, with each image captured at a predetermined exposure value within each range. For example, the camera 1 respectively captures three images of the same scene at exposure values of 105 (within the range of 90-120), 135 (within the range of 120-150), and 165 (within the range of 150-180). Each captured image comprises pixels, and each pixel has RGB color information and luminance information. The image compositing module 120 is configured for superposing the images captured to generate the HDR image. The image compositing module 120 composites the luminance information of pixels corresponding to same locations in each of the images according to the tone mapping technique. The image storing module 130 is configured for storing the HDR image in the storage module 12 in a format designated by the user. The designated format may be, but is not limited to, the JPEG format or the raw format.

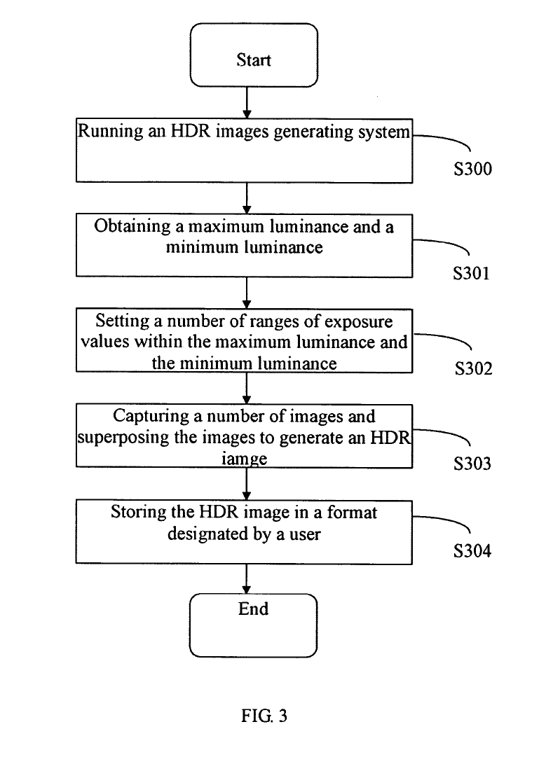

FIG. 3 is a flow chart of a method for generating HDR images in accordance with the exemplary embodiment. In Step S300, after the user selects the HDR mode for generating the HDR images, the camera 1 runs the system 10. In Step S301, the luminance acquisition module obtains the maximum luminance and the minimum luminance of the scene to be captured. Generally, the maximum luminance and the minimum luminance of the scene to be captured are between 0 to 255. For example, the maximum luminance of the scene to be captured may be 180, and the minimum luminance of the scene to be captured may be 90. In Step S302, the exposure value setting module 110 sets a plurality of ranges of exposure values according to the maximum luminance and the minimum luminance. For example, the ranges of the exposure values corresponding to the maximum luminance and the minimum luminance may be set as 90 to 120, 120 to 150, and 150 to 180.

In Step S303, the user pushes a shutter button of the camera 1, then the camera 1 automatically captures a number of images of the same scene, each image captured at a predetermined exposure value within each range, respectively. For example, the camera 1 respectively captures three images of the same scene at exposure values of 105 (within the range of 90-120), 135 (within the range of 120-150), and 165 (within the range of 150-180). Each captured image comprises pixels, and each pixel has RGB color information and luminance information. The image compositing module 120 superposes the images to generate an HDR image by compositing the luminance information of pixels having same locations in each image according to the tone mapping technique. In Step S304, the image storing module 130 stores the HDR image in a designated format in the storage module 12. The designated format may be, but is not limited to, the JPEG format or the raw format.

The system 10 and the method described above allow for integration of HDR imaging into digital cameras, mobile phones, or any other apparatus capable of capturing digital images. Further, use of the system 10 is much more convenient, and saves a great amount of time.

It should be emphasized that the above-described embodiments of the present invention, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for acquiring high dynamic range (HDR) images, the system running in an electronic device, the system comprising:
a luminance acquisition module configured for obtaining a maximum luminance and a minimum luminance of a scene to be captured;
an exposure value setting module configured for setting a first range of exposure values of the electronic device and a second range of exposure values of the electronic device according to the maximum luminance and the minimum luminance; and
an image compositing module configured for receiving a first image of the scene captured according to the first range of exposure values and a second image of the scene captured according to the second range of the exposure values, and superposing the first image and the second image to generate the HDR image by compositing luminance information of first pixels of the first image and luminance information of second pixels of the second image by using a tone mapping technique, the first pixels having corresponding locations in the first image to locations of the second pixels in the second image.

2. The system according to claim 1, further comprising an image storing module for storing the HDR image.

3. The system according to claim 1, wherein the HDR image is stored in a JPEG or raw format.

4. The system according to claim 1, wherein the maximum luminance and the minimum luminance are in a range of 0 to 255.

5. The system according to claim 1, wherein the electronic device is a mobile phone with a charge coupled device (CCD) or a digital apparatus with a CCD.

6. A method for generating a high dynamic range (HDR) image, the method comprising:
obtaining a maximum luminance and a minimum luminance of a scene to be captured;
setting a first range of exposure values and a second range of exposure values both corresponding to the maximum luminance and the minimum luminance;
capturing a first image of the scene according to the first range of exposure values comprising a first pixel located at a first location having color information and luminance information, and a second image of the scene according to the second range of exposure values comprising a second pixel located at a second location corresponding to the first location having color information and luminance information; and
superposing the first image and the second image by compositing the luminance information of the first pixel and the luminance information of the second pixel according to a tone mapping technique to generate the HDR image.

7. The method according to claim 6, further comprising:
storing the HDR image in a JPEG or raw format.

8. The method according to claim 6, wherein the method can be used in a camera, a mobile phone with a charge coupled device (CCD), or a digital apparatus with a CCD.
